(19) United States
(12) Patent Application Publication
(10) Pub. No.: US 2001/0023440 A1
(43) Pub. Date: Sep. 20, 2001

(54) DIRECTORY-SERVICES-BASED LAUNCHER FOR LOAD-BALANCED, FAULT-TOLERANT, ACCESS TO CLOSEST RESOURCES

(76) Inventors: NICHOLAS H. FRANKLIN, LEHI, UT (US); BILL GUY BODINE, OREM, UT (US); RANDALL C. COOK, SALEM, UT (US); MATTHEW G. BROOKS, OREM, UT (US); CALVIN R. GAISFORD, PROVO, UT (US); DAMON V. JANIS, PROVO, UT (US); KYRT V. NAY, MAPLETON, UT (US)

Correspondence Address: MADSON & METCALF, GATEWAY TOWER WEST, 15 WEST SOUTH TMPLE, SUITE 900, SALT LAKE CITY, UT, 04101, US

(21) Appl. No.: 08/940,789

(22) Filed: Sep. 30, 1997

(51) Int. Cl. G06F 15/173

(52) U.S. Cl. 709/226

(57) ABSTRACT

A directory services system includes a resource object, such as an application object for accessing a resource associated with the resource object. Attributes of the resource object reflect proximity of the actual resource to a user, in some measurable, physical dimension. The proximity attributes may be used to access functionally equivalent instances of a resource object based on proximity. Also, load balancing, fault tolerance, and other factors may be relied upon to select a preferred resource whenever a requested resource is unavailable. A resource, via its resource object in the directory services database, may be easily disabled for maintenance, or any other reason by setting a new disabling attribute in the object.

### BACKGROUND

1. The Field of the Invention

This invention relates to networked computer systems and, more particularly, to novel systems and methods for providing fault-tolerant, load-balanced, access to networked resources, using directory services systems, as well as temporary removal of resources from service with minimum effort.

2. The Background Art

The present invention relies on, and improves upon, the management of application programs in a computer network by an application launcher or network application launcher programmed for managing applications in a multi-server network through the use of application objects in a directory services database.

Modern computer networks may contain several server machines as well as numerous client machines. The servers typically provide file access, printer access, and other services to users who are stationed at the client machines. Large networks may contain dozens of servers and hundreds of clients administered by a “network administrator” or “administrator” for hundreds of “users.” Administrators are also users.

A wide variety of application programs such as word processors, spreadsheets, database managers, program development tools, and the like (collectively, “applications”) are typically found on one or more servers in the network, but underutilized. Necessary file access rights and execution environments must be provided by the administrator, and users need notification. Sometimes a user must locate and access an application whose executable codes are scattered among many servers, thereby making administration difficult.

In addition to an executable code, other resources are typically required by an application before it can successfully execute. In some cases, it is necessary to map drives, to capture printer ports, or to specify a working directory for files which will hold intermediate or final data produced by the application. Access to files or directories may require that the user have read, write, or other rights. In some network environments, a particular application will run more efficiently or effectively if its execution is preceded by a set of commands found in a startup script, or if its execution is followed by a set of commands found in a shutdown script. Many applications allow or require parameters to be passed to the application's executable code on the same command line which invokes that code.

Thus, in addition to maintaining the location of the executable code, users and administrators who manually maintain records regarding applications often find it helpful or necessary to maintain additional information regarding the execution environment of each application, such as drive mappings, printer port requirements, working directory names, access rights, scripts, and command line parameters. In practice, this additional information is at least as widely scattered as the executable codes and is often stored in different formats by different persons. Many users lack the expertise, the time, or both, to manually manage such information. After an application has been on the network for sometime, it is not unusual for inconsistent versions of execution environment information to be found in different formats on different machines throughout the network.

Thus, a network application launcher (e.g. Novell's NAL) provides computer-implemented methods and apparatus for consistently tracking the location of application program executable codes in a network. Reduced administrative effort is required for changes in the location of application program executable codes or changes in other information needed to execute an application. NAL tracks and employs additional information used to execute an application program, such as drive mappings, printer port requirements, working directory names, scripts, and/or command line parameters.

An instance of a resource may be unavailable for any of several reasons. Fault tolerance is needed so that a user can transparently obtain access to an equivalent instance of that resource (e.g. application), preferably from a “closest” (e.g. as to time, space, loading, latency, geography, or other suitable measure of distance) available resource. Thus, load-balancing between resources in “close” proximity, or fault-tolerance by accessing a more remote, equivalent resource, are very desirable.

When users travel from one work site to another, they often prefer to maintain the performance and familiarity of the network they ordinarily use. Users who must work away from the normal place of business will typically have certain software applications and other resources on which they depend. An application is typically launched from a server where a user has established rights.

Upon traveling to a remote location, a user may desire to access the closest possible server hosting a particular application. This may also minimize the time required to load the application. Likewise, a user typically desires the least interaction possible to launch an application.

What is needed is a convenience for users who travel, providing to them the same services on remote servers that they enjoy on their local area networks.

Moreover, an administrator may need to remove a server temporarily from service. A simple means to do so without laboriously removing and later replacing all rights, access, setup data, etc. is needed.

### BRIEF SUMMARY AND OBJECTS OF THE INVENTION

In view of the foregoing, it is a primary object of the present invention to provide load-balancing, fault-tolerance, access to a “closest” resource, and simple disabling of an instance of a resource transparently to a user. In general, any resource may be located and used (consumed) over a network by the appropriate service corresponding to the resource. Thus, herein, applications are used by way of example of a resource and application objects are examples of any suitable resource object.

The present invention's methods and apparatus for centrally managing application programs in a computer network, improve NAL with load-balancing, fault-tolerance, providing easy access to a closest instance of a resource, and a simple, reversible disabling of a resource without laborious removal and replacement of file system and directory services rights and environment configuration.

The present invention further modifies a database schema and executables (utilities) for managing its information. The database schema defines resources that can be represented, so network administrators have an efficient and effective way to make resources available on the network, to provide load-balancing, fault-tolerance, and closest access by making networked resources available even if a primary server becomes unavailable. Controlling access to a resource may be done simply and transparently to network users, or groups of users, needing particular network resources.

The resources may be represented in a modified directory services database that includes application objects representing application programs, such as word processors and spreadsheets, that reside on the network. The modifications to the schema provided by the present invention support the creation, deletion, alteration, management, and consumption of attributes in application objects in the network directory services (DS or NDS) database. In one embodiment, administrative routines for managing application objects are provided through “snap-in” modules that extend familiar administration tools presently used, for example, in Novell NetWare networks' NW Admin.

Each application object may represent one instance of an application and its execution environment, including, for example, the location of at least one executable code, a brief name that identifies the application, an icon, the location of the application's working directory, drive mappings and printer port captures needed, and the command line parameters (if any) that should be passed to the application to begin execution. Alternative embodiments of application objects include a site list, fault-tolerance list, and load-balancing list for identifying a closest available, equivalent instance of a resource (e.g. application), and a disabling flag for easily removing such availability.

In one embodiment, the application launcher allows a user to browse through the application objects which represent the applications available to that user and to view the information currently stored in the objects. When it is requested to launch an application, the launcher uses the information in the application object to set up execution environment resources needed by the application, to then create a process which executes the application, and to finally clean up after the application terminates. Resources setup typically involves mapping drives and capturing printer ports as needed; setup may also involve running a startup script. After the application terminates, the launcher cleans up by unmapping drives, releasing captured ports, and detaching from servers as needed. Cleaning up also includes running a shutdown script if one is provided.

The present inventions provides additional attributes for a resource object, such as, for example, an application object, including a load-balancing list pointing to “nearby,” equivalent instances thereof, a fault-tolerance list of “more-distant,” equivalent instances, which may be ordered in any suitable manner, and a site list of remotely located, equivalent instances for access by a user transparently. Alternatively, a single list of alternate equivalent resources may be ordered or ranked by some proximity attribute. Moreover, a disabling flag attribute may be set by administration to remove an instance temporarily from service (access) for any reason, without requiring the usual, time-consuming, laborious, and resource-intensive setup or clean up processes.

Other functions may also be added. The new functional attributes store key information in the central DS database, which is managed through specified administrator tools and user interfaces. Snap-ins are added to these tools to manage the new attributes. Database updates are thus readily performed with the administrator tools. The application launcher is provided with application programming interfaces (APIs) in dynamically linked libraries (DLLs) as executables for consuming the attributes in order to execute properly and transparently (to a user) an available, closest instance of a desired application.

To provide convenience for traveling users, a system administrator may edit certain attributes in an application object. These attributes are created for specifying a logical link between virtually identical instances of application objects and applications. Thus, even though different instances or copies of an application may be hosted on different servers, they are logically the same, and may be so identified by proper values of attributes in an application object.

In one embodiment, an apparatus and method in accordance with the invention may provide load-balancing. For example, different servers may host different instances of an application. Nevertheless, a single user may be directed to any appropriate server in order to balance the load on a set of servers. By creating attributes in an application object for controlling or identifying available servers having a desired application hosted thereon, those may be balanced. Moreover, fault-tolerance may be provided.

For example, lists of available servers hosting a particular application may be contained as attributes within an application object. Thus, the unavailability of a particular server may be handled similarly to the load-balancing solution. That is, an unavailable server is simply bypassed in favor of an available server identified in an application object available within a directory services system.

In one embodiment, fault tolerance, load-balancing, and access to a closest resource may be effected in very similar ways. For example, load-balancing may be done with resources of closest proximity to a user. Meanwhile, fault-tolerance lists of available servers may be maintained in a application object to direct a user to more remote servers when a local server is unavailable. Similarly, for traveling users, access to a closest resource may be provided. A site list giving geographical locations and other necessary identification of resources, such as applications, may be accessed to serve the traveling user. Thus, a user object in a directory services system may identify certain rights and environments, as well as applications, preferred by a user.

A site list associated with an application object may identify remote sites for the corresponding application. Accordingly, a directory services system may identify a user, traveling to a remote site, retrieve the association lists from a user object associated with the user, retrieve a site list from a user's application objects or the application objects associated with the user object. Then, the remote server may provide to the traveling user corresponding applications identified in the site list and virtually identical to the desired application the user would have used on the local server at home. Thus, a directory services system may, by modification of its resource objects (e.g. application object) to include certain proximity-oriented attributes, provide ease of travel as well as multi-tolerance and load-balancing.

Thus, an administrator is able to disable an instance of an application while allowing users to use on other instances thereof.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a system of networked computers in accordance with the invention;

FIG. 2 is a schematic block diagram of an individual node in a network system such as that of FIG. 1;

FIG. 3 is schematic block diagram of a directory services system on a server, such as a server of FIG. 1 and FIG. 2;

FIG. 4 is a schematic block diagram of a container object in a directory services system of FIG. 3;

FIG. 5 is a schematic block diagram of a group object in a directory services system of FIG. 3;

FIG. 6 is a schematic block diagram of a user object in the directory services system of FIG. 3;

FIG. 7 is a schematic block diagram of an application object in accordance with the invention for inclusion in the directory services system of FIG. 3;

FIG. 8 is a schematic block diagram of a network application launcher system illustrating data structures for administrating and executing functions and data structures in accordance with the invention;

FIG. 9 is a schematic block diagram of data structures and operational access for one embodiment of an architecture for a network application launcher, such as that of FIG. 8;

FIG. 10 is a schematic block diagram of an enterprise-wide computer system in accordance with the invention, which may use the directory services system of FIG. 3, in conjunction with the data structures and architecture of FIGS. 2-9; a schematic block diagram of a method for implementing a load-balancing in fault tolerance; and

FIG. 11 is a schematic block diagram of methods for implementing a closest resource selection function and a disabling function for an instance of an object.

### DETAILED DESCRIPTION OF THE PREFERRED EMBODIMENTS

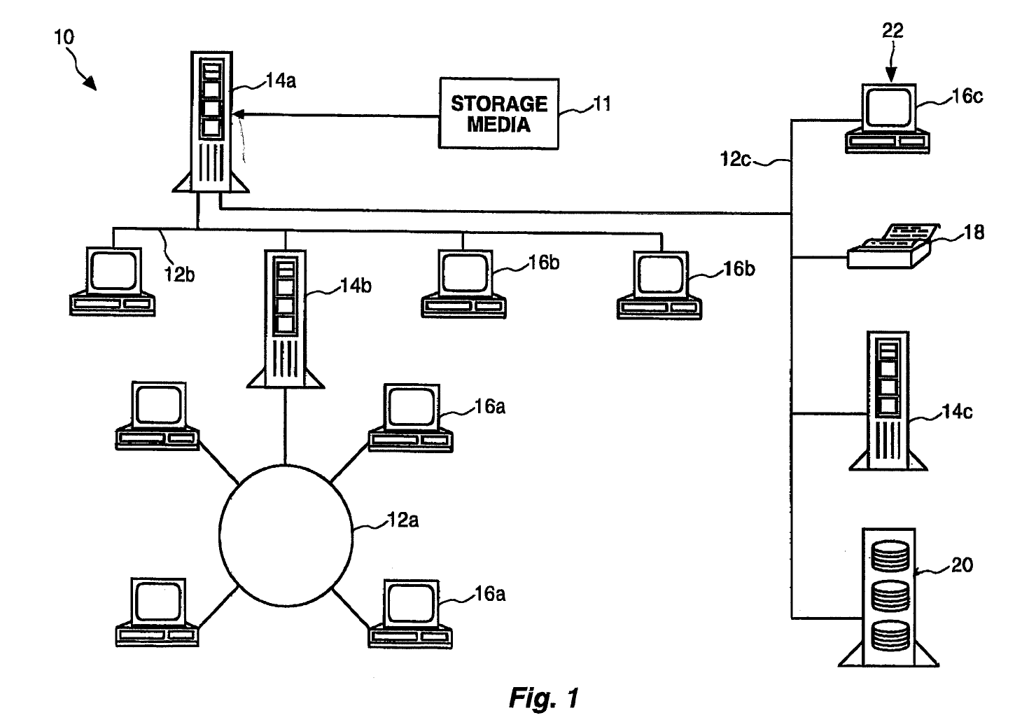

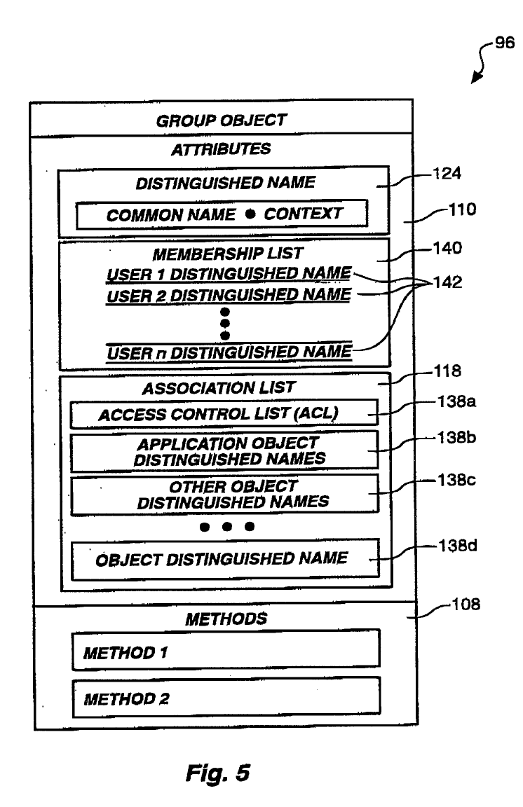

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 11, is not intended to limit the scope of the invention, as claimed, but is merely representative of the presently preferred embodiments of the invention.

The presently preferred embodiments of the invention will be best understood by reference to the drawings, wherein like parts are designated by like numerals throughout.

Referring now to FIG. 1, a system 10 or network 10 of computers may include a storage medium accessible to one or more networks 12 (e.g. networks 12a, 12b, 12c). A network 12 may be provided service of files, applications, or other functions and data structures by a server 14 (e.g. servers 14a, 14b, 14c). Each network 12 may interconnect an appropriate number of nodes 16 or computers 16 of which a server 14 or router 14 may be warrant.

In addition, various printers 18, storage devices 20, remote nodes 16 and the like may serve as resources 22 available to nodes 16 in the network 12.

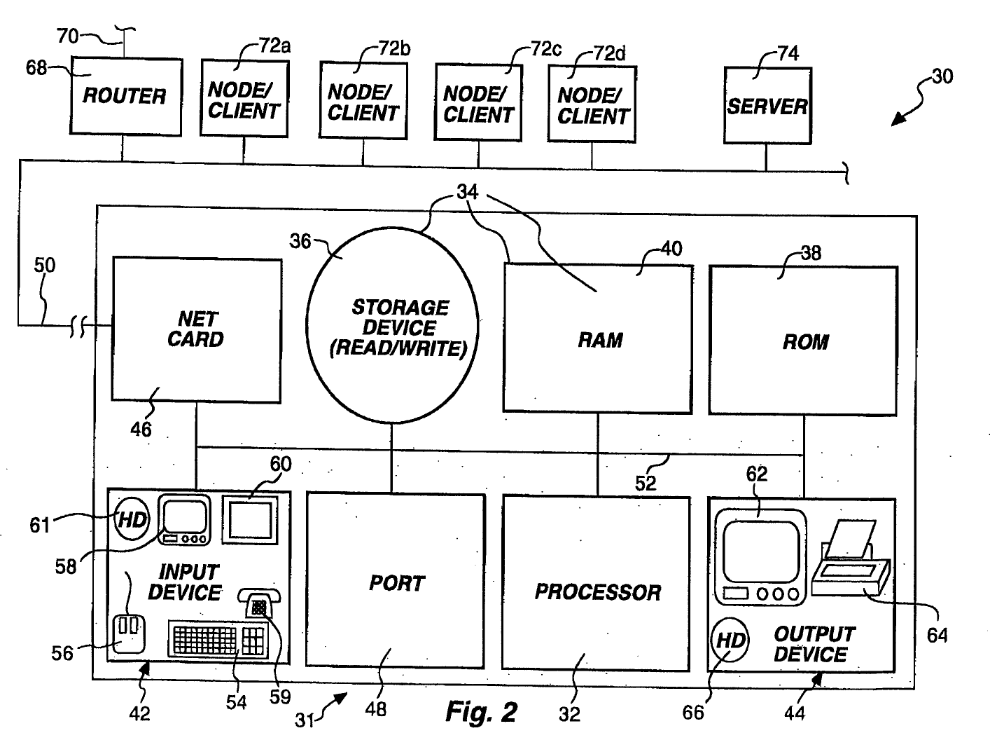

Referring now to FIG. 2, in general, any network 30 or apparatus 10, such as the network system 10 or apparatus 10 of FIG. 1, may include nodes 31 (e.g. nodes 14, 16, 70, 72, 74). Each node 31 may include a processor 32 and memory devices 34, such as storage devices 36, read only memory (ROM) 38, and random access memory (RAM) 40, sometimes referred to as operational memory. The node 31 may include a variety of input devices 42, and output devices 44 whether dedicated as illustrated in FIG. 2, or available over a network 12 of FIG. 1, as resources 22.

Typically, a node 31 may include a network card 46 for connecting to a network 50 (e.g. network 12) outwardly, and a bus 52 for interconnecting elements internally.

Input devices 42 may include a keyboard 54, a mouse 56 or other pointing device such as a stylus or graphics tablet, a touch screen 58, a scanner 60, or even a storage device 61 for providing data to the node 31. Similarly, output devices 44 may include monitor 62, printer 64, storage devices 66, and the like for providing data from the node 31.

A router 68 may interconnect networks 50, 70 where each network 50, 70 may include some simple nodes 72, such as clients 72a-72d, and servers 74. Networks 12, 50, 70 are well understood in the art. Accordingly, the hardware illustrated in by way of an example, and not limitation as to the hardware suite on which the invention may be implemented. More or less equipment may be used in many particular embodiments.

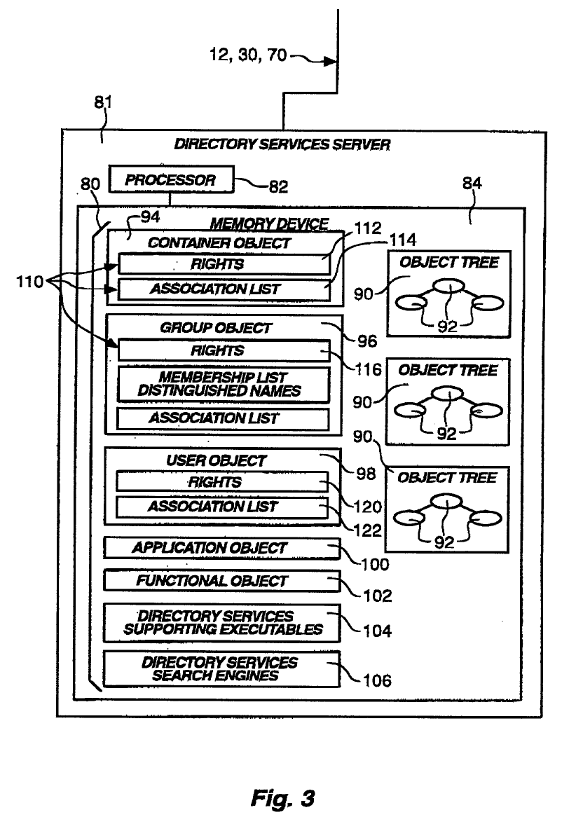

Referring now to FIG. 3, directory services system 80 may be hosted on a directory services server 81. A directory services system 80 is typically highly distributed among nodes 31 over interconnected networks 12, 30, 50, 70, and thus may be referred to simply as directory services, regardless of which particular data structures and hardware may be implicated or required for a particular task.

Nevertheless, a directory services system 80, 81 may include a processor 82 for executing executables, where an executable may be any executable data structures from a single machine instruction to a sophisticated system of applications. The process 82 may rely on memory device 84 to create, manage, or store object trees 90 of individual objects 92 linked in a hierarchical relationship. For example, container objects 94 can contain other objects, whereas a group object 96 merely contains information identifying relationships between objects 92, which need not be hierarchical. A user object 98 is one example of an object that may be identified by a group object 96, and contained in a container object 94 (a parent 94 to the leaf 98). One very useful object 92 is an application object 100, identifying certain important information associated with an actual executable file corresponding to an application. Various application objects 100, 102 may be stored and related in object trees 90 in a directory services system 80. A directory services system 80 includes numerous executables 104 known in the art and well described elsewhere. Likewise, directory services search engines 106, or simply search engines 106, may include sophisticated methodologies for creating and executing theories to locate specific objects 92 in an object tree 90 within a directory services system 80. One should keep in mind that, in general, a directory services system 80 may actually be distributed throughout the memory devices 11, 34, 84 of any appropriate number of networks 12, 30, 50, 70. Typically, an object 92 may be created to include methods 108, attributes, or both, as known in the art. For example, containers 94, groups 96, users 98, and applications 100 (abbreviating the names of these objects to a single word each) may each contain, respectively, certain rights 112, 116, 120 or rights attributes 112, 116, 120, and one or more association lists 114, 118, 122, for identifying other objects 90 to having some relationship thereto.

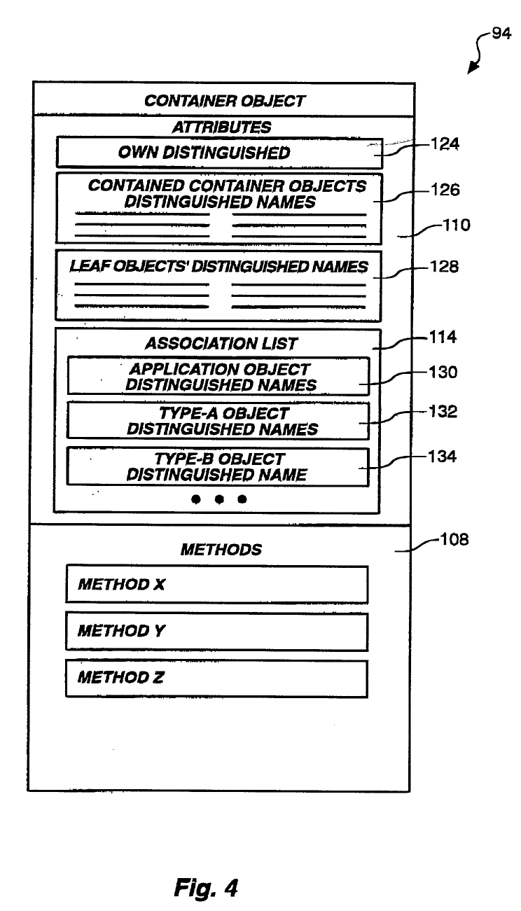

Referring now to FIGS. 4-6, in view of FIG. 3, an object 92, such as a container object 94, may include an attribute 110 of its own distinguished name 124. Likewise, for container objects 94, a list 156 of distinguished names contained therein or thereby is included, as well as a list 128 of leaf objects' distinguished names contained therein. The association list 114 may identify certain distinguished names 130, 132, 134 of application objects or other resource objects associated with the object 94, 96, 98 in question.

A group object 96 may include a binding data structure, typically an association list 118, identifying associations, such as, for example, access control lists 138a, application object distinguished names 138b, and distinguished names 138c, 138d of other associated resource and other objects. A group object 96 may also have certain unique attributes 110, such as a membership list 140 identifying the distinguished names 142 of all users or user objects 98 having membership in the group 96.

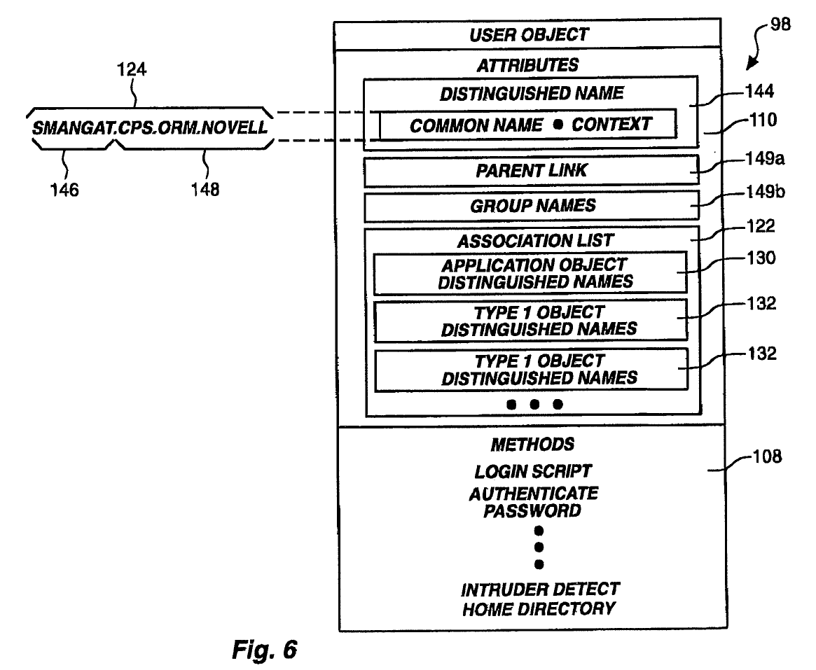

A user object 98 is associated with an individual user. The distinguished name 144 of FIG. 6 is exemplary of all distinguished names 124. Each distinguished name 124 typically includes a common name 146 in association with a context 148. Context 148 may include acronyms, abbreviations, or other identifications of organizations, geography, logical relationships, and enterprises, as illustrated. Context 148 is sometimes thought of as a logical path or may be so configured in a particular directory services system 80.

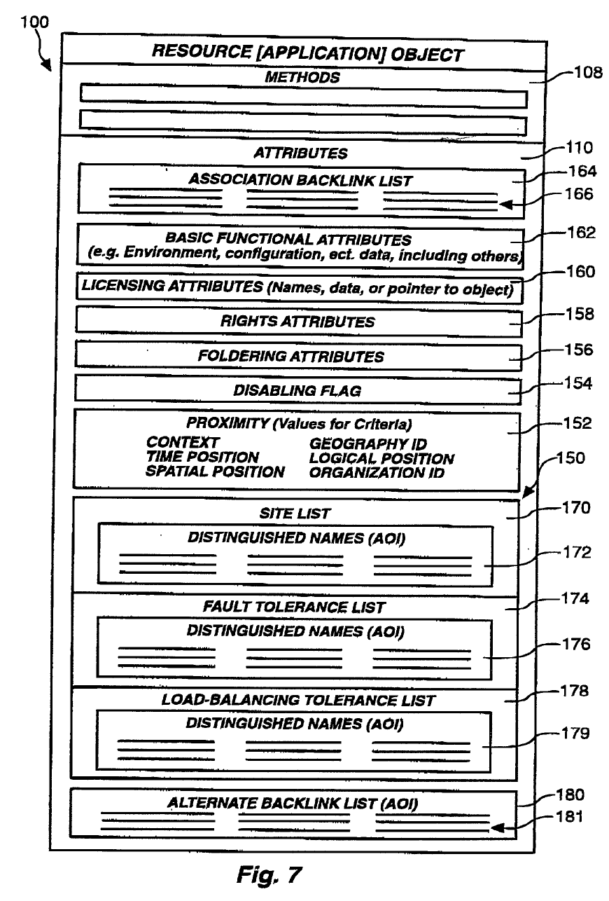

Referring now to FIG. 7, an application object 100, in accordance with the invention, may include methods 108 and attributes 110. In one presently preferred embodiment, reliability attributes 150 (alternatively referred to as redundancy attributes, hierarchy of redundancy, or instance relation attributes) may be added to an application object 100. A proximity attribute 152 may provide values associated with the application object 100 for determining the proximity of the application object 100 and its associated resources to a particular hardware location or physical user. The proximity attribute 152 may reflect a measurement, context, a time position or time for access, spatial position, organizational identification, logical position, or geographical identifier for identifying a proximity of an application object 100 with respect to a coordinate system locating another object, such as a user object 98, group object 96, or container object 94. Proximity attribute 152 may reflect any measurement criterion effective for determining relative ease of access by one object 92 to a particular application object 100. A disabling flag 154 may provide an ability to determine whether or not an application object 100 has been removed from access. Configuration of environments, rights, masks, associations, and the like may be relatively time consuming and burdensome to the system. To manage such allocation of configuration information when an application object 100 is to be removed from service for a short period of time, such as during maintenance, may be a colossal waste of time. Thus, a disabling flag 154 may be set as an attribute to be read by any executable attempting to access the application object 100. A disabling flag 154 allows the application object 100 to exist, fully configured, and yet be inaccessible. Thus, any executable seeking to access an application object 100 may be referred to the redundancy attributes 150 in order to find an equivalent instance to be used in place of the application object 100. A foldering attribute 156 may be provided to store information indexing the associations corresponding to an application object 100 and other objects 92 in a directory services database 90. Rights attributes 158 may contain any information associated with authorizations appropriate to access of or by an application object 100. Similarly, licensing attributes 160 may identify authorizations, charges, and other administrative information required for licensing an application associated with an application object 100. As understood in directory services systems, an object 92 (e.g. application object 100) represents logically certain files of data or executables (e.g. an application), and each is often spoken of as the other, though they are not actually the same thing. In general, the attributes 150-160 are new specialized attributes associated with certain features corresponding to the inventions disclosed herein, and may be incorporated into the basic functional attributes 162 associated with application objects 100 in general. Thus, in certain embodiments, basic functional attributes 162 may include environment information, configuration information, and other data. In other embodiments, the attributes 150-160 may be included in the basic functional attributes 162. Meanwhile, other functional attributes may be added for special functionality. A key attribute 110 of a resource object 100, such as an application object 100, may be an association backlink list 164 containing distinguished names 166 of objects associated in some appropriate way with the resource object 100. The association backlink list 110 may be used for binding security, and management of access to the resource represented by the resource object 100.

The hierarchy 150 or redundancy attributes 150 may include a site list 170 of distinguished names 172, a fault-tolerance list 174 of distinguished names 176, a load-balancing list 178 of distinguished names 179, or all lists 170, 174, 178, where the distinguished names 172, 176, 179 represent alternative instances of application objects or application object instances (AOI). The distinguished names 172, 176, 179 may be relied upon when the application object 100 is unavailable for access. All those certain preferred embodiments of an apparatus and method in accordance with the invention may use load-balancing, fault-tolerance, and remoteness of a user from a home network, to justify hierarchical reliance on the load-balancing list 178, fault-tolerance list 174, and site list 170, in that order, and the proximity value 152 may also be used for determining, in order and instance of an application object 100 to be accessed, based solely on the proximity attribute 152. For example, if the disabling flag 154 is set to make the application object 100 inaccessible, for any reason, the hierarchy 150 may be relied upon in conjunction with the proximity attribute 152 in order to find the “closest” available instance of the application object 100 for access.

An alternate backlink list 180 may include distinguished names 181 of objects 92 (e.g. application object instances equivalent application object 100) in which the application object 100 is identified by a respective redundancy attribute 150. Thus, the alternative backlink list 180 provides administrative information for cleaning up associations throughout a directory services object tree 90.

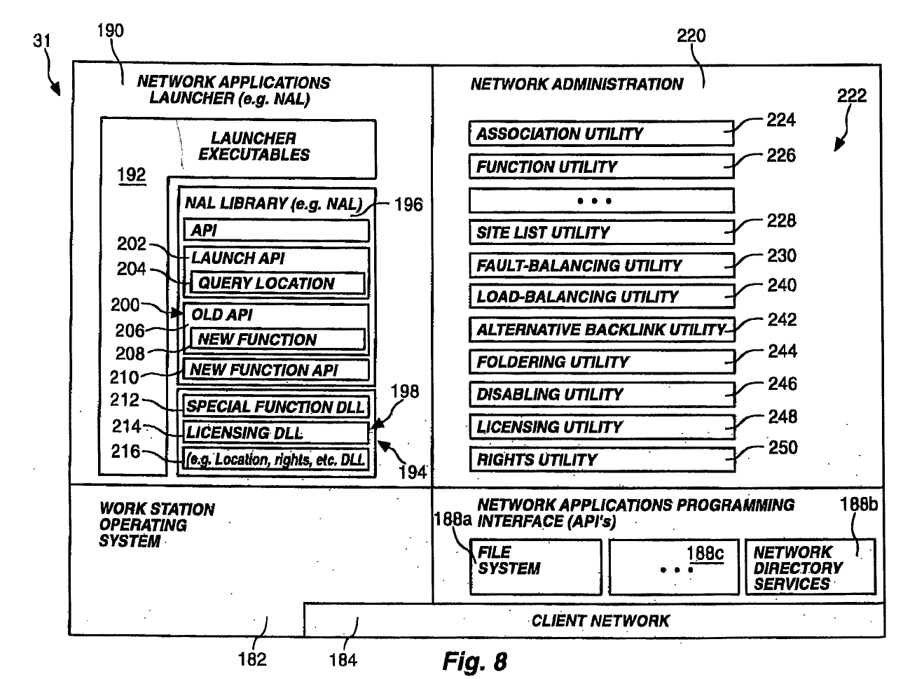

Referring now to FIG. 8, a node 31 may contain executables in a storage device 34 for executing in a processor 32 (see FIG. 2) in accordance with the invention. An operating system 182 (workstation operating system 182) may interface with a client 184, alternatively called a client module or network client 184, connecting to a network 50. Network application programming interfaces (API's) 186 may include biosystem API's 188a, network directory services API's 188b, and other API's 188c interfacing directly with the client 184.

A network application launcher (NAL) 190, interfacing with the operating system 182 may include various launcher executables 192. Executables 192 may include single instructions, applications, libraries, functions, and the like, including specially programmed dynamically linked libraries (DLL) 194. For example, a NAL library 196 includes various API's 200 including a launch API 202, including a query 204 programmed to query an application object 100 for location data, such as proximity attributes 152. As a practical matter, the API's 200 may include adaptations of old, or less-conventional functions such as an old API 206, provided with a new function 208 for implementing the invention. Alternatively, new functional API's 210 may be programmed for implementing certain embodiments of the invention. In yet another alternative, new DLL's 198 may be added, each DLL 198 being provided specifically for supporting a new special function in accordance with the invention. For example, a special function DLL 212 may be created for selecting a closest application object 100 to a user object 98 in a particular object tree 90. Special function DLL's 212 may be created for providing fault-tolerance executables, load-balancing executables, and remote access executables for using (consuming) the attributes 150 of an application object 100. Thus, a special function DLL 212, or a new functional API 210, or simply a new function 208 in an old API 206 may contain the executables for consuming attributes 110 of an application object 100.

In certain embodiments, a licensing DLL 214, a location DLL 216, for consuming the redundancy attributes 150, or a rights-management DLL for managing access rights, may all be included in a DLL 216 or individual DLL's 198.

The functionality of the DLL's 194 may be accomplished in several different ways. For example, in general, a network administration module 220 may contain utilities 222 for managing (creating, modifying, deleting, etc.) attributes 110 in an object 92, such as an application object 100. The DLL's 194 may be configured to consume (use, access, read, etc.) the attributes 110 managed by the utilities 222.

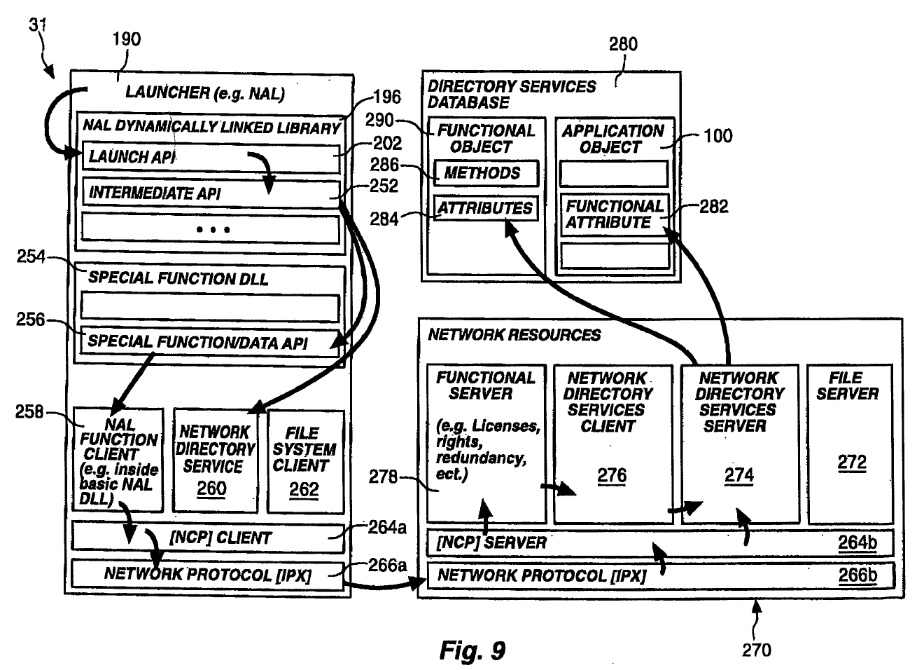

However, a simple executable such as a new function 208 adapted to implement a feature of the instant invention may completely satisfy any functional need and use of an attribute 110. Alternatively, a new functional API 210 may be programmed to access or use an attribute 110. Alternatively, a new function 208, or new API 210, may provide indirection by calling another DLL 198 (e.g. 212, 214, 216) or APIs 200 to perform or supervise a desired function. FIG. 9 further elaborates on methods and data structures for these different approaches.

The utilities 222 are also referred to as snap-ins 222, and are each associated with some specialized functional ability. Thus, in general, an association utility may manage an association list 164 in application object 100. Other functional utilities 226 may be created for any particular need. Specific needs identified for embodiments for the instant invention may include a site list utility 228 for managing distinguished names 172 in the site list 170, a fault-tolerance utility 230 for managing the distinguished names 176 in the fault-tolerance list 174, a load-balancing utility 232 for managing the distinguished names 179 in the load-balancing list 178, an alternate backlink 234 for managing the contents of the alternate backlink list 180, a foldering utility 236 for managing the foldering attributes 156, a disabling flag utility 238 for managing the disabling flag 154, a licensing utility 240 for managing the licensing attributes 160, and a rights utility 242 for managing a rights attributes 158.

In general, an object 92 (e.g. application object 100) has attributes 110 and may have methods 108 for using certain of the attributes 110. A network administration module 220 manages the attributes 110 through the snap-ins 222 (utilities) in order that those attributes 110 will be available for use by API's 200 in the network application launcher 190. Utilities 222 may be highly distinctive, or integrate many functionalities into a single utility. The architecture choice is largely available to a developer in order to provide the most robust and adaptable system. For example, in one presently preferred embodiment, the network application launcher 190 includes a query location executable 204 in the launch API 202 of the NAL library 196. The location of an application object 100 is identified thereby. Location may actually be defined and queried by any suitable rule. In certain embodiments, location may be an identification by server, by actual spatial global positioning systems, by network directory services hierarchical position within a tree 90, by geographical location name, by context, by path, by any of the values of the proximity attribute 152, by routing speed between locations, by global addressing scheme, DHCP protocol, or the like. The query 204 may eventually access the redundancy attributes 150 and the proximity attributes 152 to resolve the query 204, select an application object instance, and complete the launch thereof.

Referring to FIG. 9, and certain features of FIGS. 2-8, a node 31 may host a launcher 190 relying on a dynamically linked library 196 of API's 200, such as a launch API 202 and intermediate API's 252 access thereby. In addition, special function DLL 254 including special function 256 operating as NAL function clients 258 with the network operating system clients 264 and network protocol 266 may access network resources 270. A file server 272, network directory services server 274, and specialized, functional servers 278 may operate as resources 270. The network resources 270, may access a directory services database 280 (via clients 276 to server 274), such as the object trees 90 (see FIG. 3) to access application objects 100, in order to provide the functional attributes 282 needed by the API's 256, 252, 202 to operate. In certain embodiments necessary attributes 284 may be provided along with methods 286, or alone, in specialized, functional objects 290 adapted to specific functions or purposes.

Referring to FIG. 9, a node 31 hosting a launcher 190 (NAL 190) relying on a NAL library 196 including a launch API 202 may call, or include, or otherwise engage, an intermediate API 252. In one embodiment, the calling API 252 may call, relying on indirection, a special function dynamically linked library 254 to access a special function API 256 adapted to the requested function, such as one of those associated with the attributes 110 of FIG. 7, DLL 194 of FIG. 8, and snap-ins 222 of FIG. 8. The special function API 256 may also be thought of as a NAL client 258 or a NAL function client 258 for accomplishing a desired function. The client 258 may then access through the network client 264 a (e.g. for example, a netware core protocol) through a network protocol 266a client module (e.g. IP, IPX, etc.) to the server portion of the network protocol 266b and network server module 264b to access a functional server 278. A functional server 278 may be dedicated to a particular function, such as the licensing, rights management, redundancy provision, or the like, in accordance with the attributes 110 and API's 200 of FIGS. 7-8. Thus, the server 278 may access a network directory services client module 276 contacting the directory services server 274 to provide access to a functional object 290 adapted to the desired function, and containing the attributes 84, methods 286, or both for accomplishing the function.

Alternatively, the launcher 190 may call the launch API 202 which, after engaging the intermediate API 252, may engage a network directory services client module 260. The client 260 may then access through the client 264a, protocol 266a, protocol 266b, and server module (interface 264b), the network directory services server 274. In this embodiment, the network directory services server 274, (server 274) may then access directly a functional attribute 282, such as any of the attributes 110 of the application object 100. Thus, in this embodiment, a calling API 252 may actually consume the attribute 110 provided in accordance with the invention implementing benefits of any particular function of the invention.

In one embodiment, a single attribute 110 may be used, in alternative embodiments, any number of the attributes 110 may be used in an application object 100, or a specialized functional object 290 program for a specific purpose. For example, a licensing object 290 may be provided, or a rights management object 290, or the like.

Thus, when a launcher 190 accesses a launch API 202, the launch API 202 may perform alone or may rely on an intermediate API 252 directly or using further in direction. The intermediate API 252 may be configured for to executing specialized function directly. Alternatively, the intermediate API 252 may engage the client 258 to obtain access to a specialized, functional object 290 for executing the desired functional features.

In yet another, third, embodiment, the intermediate API may access a network directory services client 260 in order to obtain functional attributes 282 directly from a directory services database 280 in an application object 100. Thus, high levels of sophistication may be provided in the methods 286 and attributes 284, or function attributes 282 may be accessed directly for use in API's 200, such as the API's 252, 256 programmed to provide any required skills.

In a simple, but less flexible, approach, an intermediate API 252 may have a desired executable embedded therein, or in the launch API 202 itself may have any functional executables embedded therein. Thus, programming may be simplified but rigid, or flexible, but more complex by any of the above mechanisms, the functional features of providing associations, the remote accessed at distance sites from a home network, providing fault-tolerance access to alternative objects 92, 100, load-balancing by accessing alternative servers 14, backlinking, foldering of application objects 100 or other objects 92 to be displayed, viewed, and managed in some logical hierarchy, disabling an object 92, particularly an application object 100, without having to remove and restore configuration, licensing, and rights management, may all be provided by individual combinations of attributes 110 managed by snap-ins 222 and consumed by API's 200 in the network application launcher 190.

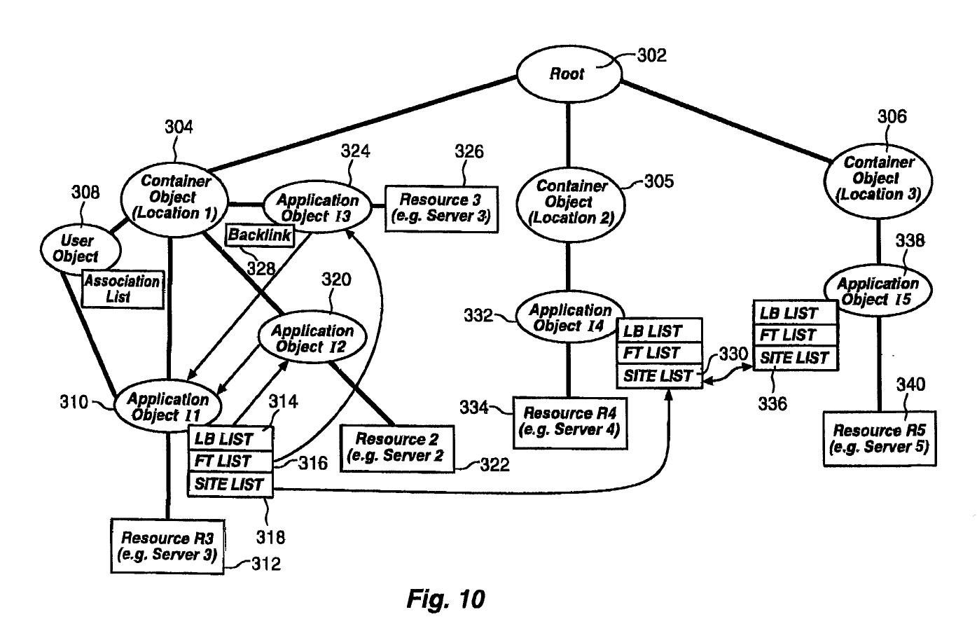

Referring to FIG. 10, in one embodiment, a directory services system 80 may include a root 302 (container 302), containing several other containers 304, 305, 306, alternatively referred to as container objects 304, 305, 306 distributed throughout the system 80 an application object 100 may have several application object instances 310, 320, 324, 332, 338, each associated with its respective resources 312, 322, 326, 334, 340, such as servers.

In one embodiment, a container 304 may contain a user object 308 associated with an application object 310. The application object 310 may include a load-balance list 314, fault-tolerance list 316, and site list 318. The load-balance list 314 may link the application object 310 to the application object 320.

A fault-tolerance list 316 may link the application object 310 with other equivalent resource objects 100, such as the application object 324.

Meanwhile, backlinks 328 may provide links back to the application object 310, from the application object 324, application object 320, and the like. If, for any reason, a user object 308 seeks access to the application object 310, the load-balance list 314 may provide information to determine whether the application object 310, or a less heavily loaded or more easily available, application object 320, should actually be provided to the user object 308. In the event that the application objects 310, 320 are unavailable, the fault-tolerance list 314 may direct user object 308 to an application object 324, providing fault-tolerance.

An individual may travel to a location associated with the container object 305, or the container object 306. Accordingly, a user object 308, logging on at a container object 305 or container object 306, may find that a site list 330, 336 identifies the linking between the application object 310 normally used by the user object 308, and the application objects 332, 338. Thus, a user, roaming to location of a container object 305, 306 remote from a home network, may nevertheless access an equivalent application object 332, 338 in lieu of the normally accessed application object 310.

Note that each of the container objects 305 may include multiple application objects 332, 338, respectively, as does the container object 304 with their resources. Thus, a user may actually require access to a load-balancing list 178, fault-tolerance list 174, site list 170, or all three when operating remotely.

In general, one may think of the load-balancing list 178, fault-tolerance list 174, and site list 170 as providing increasing the radius of access or a hierarchy of closest resources available to a user at any location.

Nevertheless, in one presently preferred embodiment, the load-balancing list 178 may be used primarily for balancing the loads on approximately equally useful and available servers, according to the respective work loads corresponding thereto.

The fault-tolerance list 174 may provide access to backup application objects 100 some “distance” away, as reflected by a proximity attribute 152 defining such “distance.” In one embodiment, only one resource object 310 need have a site list within a container 304, although the container 304 has several associated application object instances 310, 320, 324. However, such configuration details are a matter of personal choice and administration of network traffic and the associated desire for access speed and reliability, which may be balanced according to a desired management scheme.

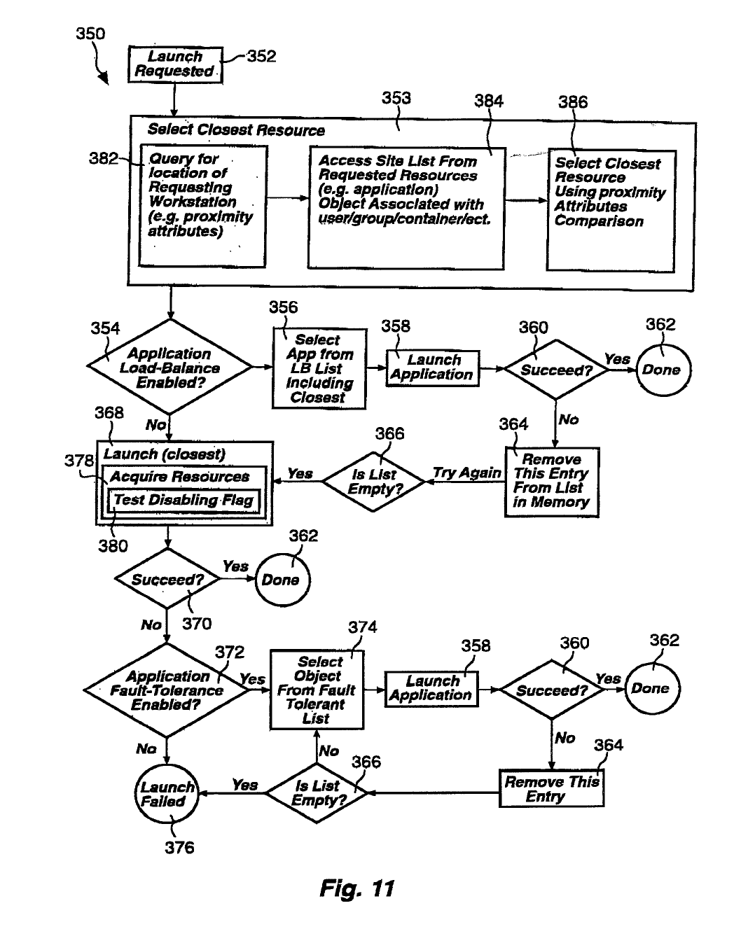

Referring now to FIG. 11, several alternative methods may be implemented with the hardware and data structures of FIGS. 1-10 to provide a desired function. In one embodiment, a request 352 for a resource (e.g. application) may be provided by a launcher 190. A test 354 determines whether load-balancing is available. A select 353 selects the closest resource available. A select 356 provides an application object from a load-balancing list 178, if available, after which a launch 358 is attempted. A test 360 determines whether the launch 358 succeeded. If so, the end 362, or done state 362, has been reached. Otherwise, a remove step 364 may delete the distinguished name 179 corresponding to the unavailable resource from the load-balancing list 178.

A test 366 determines whether the load-balancing list 178 is empty, determining whether to elect 356 a new distinguished name 179, or to move on to a launch 368 of a primary, or nearest available resource (application). The launch 368 may be a launch of an application object 100, or may merely include the remaining portion of the method 350.

A test 370 may determine whether the launch 368 is successful, preceding to a done state 362. Otherwise, a test 372 determines whether fault-tolerance is available, such as by checking for the presence or content of a fault-tolerance list 174. If available, the fault-tolerance list 174 is used by the select 374 to identify a distinguished name 176 and launch 358 the corresponding application object 100.

Nevertheless, the select 374, as well as the select 356 may be performed by any appropriate rule. For example, in one presently preferred embodiment, the select 356 is done at random, or by speed of access according to some timing or routing procedure, while the select 374 may merely operate on a list from top to bottom or a list ranked in order of proximity to (e.g. proximity attribute 152 comparison with) a specific node 31.

Thereafter, a launch 358, test 360, proceed as described above, until the test 366 identifies the fault-tolerance list 174 as having been completely consumed, without achieving the done state 362. Thus, each test 366, when answered negatively, continues the iteration of the corresponding select 374, while a positive response advances to another option available until success 362 or a launch failed state 376.

A distinguished name 172 is available from a site list 170. A select step 353 may query 382 for relative locations, using any suitable rule, programmed for the purpose, to select an application (resource) object 100. The goal is to proceed toward an eventual launch 368. Each launch 358 may be exactly the same as the launch 368.

Meanwhile, if a site list 170 is not available at any object 92 associated with a container 94, 304, 305, 306, the select 353 must find or access 384 a site list nearby or else use the only resources authorized, even from a distant location. The resource used is decided typically by a select 386 or comparison 386 of proximity attributes 152.

Any order of selection of application objects 100 may be used as a rule and an order for consuming the redundancy attributes 150 including the site list 170. In one presently preferred embodiment, the redundancy attributes 150 may constitute an ordered list (e.g. such as by proximity attributes) of instances of an application object 100 accessible according to the closest available resource.

If an application object 100 is unavailable for any reason, particularly because a disabling flag 154 has been set to remove the application object 100 from being launched, the launch may be immediately failed, and a select 353 with selects 356, 374 may iterate to another instance (e.g. closest resource, fault tolerance options, load-balancing options, etc.) equivalent to the application object 100 requested.

The proximity attribute 152 may be relied upon to select an application object 100 or other resource 170, according to the value to the proximity attribute 152. Thus, the redundancy attributes 150 may all be ordered in a single list. The management of load-balancing list 178, fault-tolerance list 174, and site list 170, may be done independently from one another in order to optimize performance of their respective access-control functions.

Note that the launches 368, 358 may each contain an acquire step 378 for acquiring resources 100. A test 380 in each such acquire step may test the disabling flag attribute 154. If the flag 154 is set to prohibit the use of a particular instance, no great effort is needed to scrub the launch and select a different instance, according to the method. Thus, the disabling flag attribute 154 and an executable 380 to consume the attribute 154 greatly simplify temporary disabling of any instance of any resource 100, 170, etc.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for selecting a resource, the apparatus comprising a computer system comprising a processor, for executing executable data structures, operably connected to a memory device for storing the executable data structures and associated operational data structures, said executable and operational data structures comprising:
a directory services system for managing objects, including at least one resource object corresponding to a resource, and for relating the objects to one another;
a resource object of the at least one resource object, comprising a special function attribute;
a utility, executable to manage the value of the special function attribute;
a consuming executable programmed to perform the special function, using the special function attribute.

2. The apparatus of claim 1, wherein the special function attribute is selected from the group consisting of a load-balancing list, a fault-tolerance list, a proximity attribute, a site list of sites bound to corresponding proximity attributes, and a disabling flag effective to disable an instance of the resource object.

3. The apparatus of claim 1, wherein the consuming executable is effective to select a closest resource corresponding to the resource object and functionally equivalent to a requested resource.

4. The apparatus of claim 1, wherein the special function attribute is a disabling flag effective to prevent access to an instance of a requested resource corresponding to the resource object.

5. The apparatus of claim 1, wherein the resource object further comprises a proximity attribute corresponding to a value reflecting a relative preferability between the resource object and another resource object functionally equivalent thereto.

6. The apparatus of claim 1, wherein the resource object corresponds to a physical entity for performing a physical function for a plurality of nodes networked together in the computer system.

7. The apparatus of claim 6, wherein the plurality of nodes is configured to provide a directory services server effective to store and manage the objects, a client node for accessing the objects provided by the directory services server, and programmed to select a resource corresponding to the resource object by comparing a proximity attribute of the resource object to a location of the client node.

8. The apparatus of claim 7, wherein the proximity attribute reflects a value of a parameter selected from a physical distance, a routing speed over a network, a geographical name, a context of a name, and a logical organization identification.

9. The apparatus of claim 1 wherein the resource object contains a proximity attribute effective to identify a physical location of a resource, corresponding to the resource object, with respect to a physical location of a node, corresponding to a user, and wherein the consuming executable is effective to select the resource based on the proximity attribute.

10. The apparatus of claim 9, wherein the proximity attribute is contained within the context of a distinguished name corresponding to the resource object.

11. A method for selecting a resource, the method comprising:
providing a directory services system for managing and relating objects, including a resource object corresponding to a resource, the resource object having a selection attribute for distinguishing the resource object from another, functionally equivalent, alternative instance of the resource object;
requesting a launch of the resource for providing a function;
selecting a closest instance of the resource using the selection attribute.

12. The method of claim 11, wherein the resource object further comprises a list for identifying a plurality of the alternative instances, the list comprising entries, each corresponding to a respective alternative instance bound to a value of the selection attribute for selecting from the plurality of alternative instances.

13. The method of claim 12, wherein the selection attribute corresponds a value reflecting a parameter selected from the group consisting of a physical distance, a routing speed, geographical location, a processor loading, and a logical relationship.

14. The method of claim 13, wherein the parameter reflects a distance.

15. The method of claim 14, wherein the parameter is contained within a distinguished name corresponding to the resource object.

16. The method of claim 11, further comprising providing a disabling flag attribute effective to render inaccessible the resource object, while leaving other relationships intact with respect to the resource object.

17. The method of claim 11, further comprising selecting an alternative resource object based on load balancing between the resource object and the alternative resource object.

18. The method of claim 11, further comprising selecting an alternative resource object based on fault-tolerance attributes providing redundancy when the resource object is unavailable.

19. A memory device for storing data structures, the data structures comprising:
a directory services system for managing objects, including at least one resource object corresponding to a resource, and for relating the objects to one another;
a resource object of the at least one resource object, comprising a special function attribute;
a utility, executable to manage the value of the special function attribute;
a consuming executable programmed to perform the special function, using the special function attribute.

20. The memory device of claim 19, wherein the special function attribute is a disabling flag effective to disable an instance of the resource object while leaving other environment data and relationships, associated therewith, intact.
